(19) United States
(12) Patent Application Publication
(10) Pub. No.: US 2002/0125635 A1
(43) Pub. Date: Sep. 12, 2002

(54) Multi-line gaming machine and method

(76) Inventor: Steven J. Lemberg, Bloomfield Hills, MI (US)

Correspondence Address: John G. Posa, Gifford, Krass, Groh, Suite 400, 280 N. Old Woodward Ave., Birmingham, MI, 48009, US

(21) Appl. No.: 09/803,874

(22) Filed: Mar. 12, 2001

(51) Int. Cl. A63F 1/18; A63F 13/00

(52) U.S. Cl. 273/139

(57) ABSTRACT

A multi-line gaming machine and method of play combines features of rolling dice and slot-type machines. A player-facing front panel having a plurality of windows, each window being operative to display one of a plurality of changing symbols, and wherein pairs of windows represent lines of play. A player activates the machine, typically through the delivery of money or tokens sufficient to fund one or more lines of play, followed by the pull of a level or other type of control, to cause the window displays to change. When the displays come to rest, the apparatus alerts a player to various WIN/LOSS combinations, including a WIN if one or more predetermined winning combinations of numbers or symbols appear in the windows, a LOSS if one or more predetermined losing combinations of the numbers or symbols appear in the windows, and a POINT useful in future play of the machine in the absence of a WIN or LOSS. In the preferred embodiment, there are three or more windows, and the pairs of windows representing different lines of play are overlapping such that each window comprises one half of a different line. Also, the numbers and symbols are preferably representative of faces on a specialized die, such that the activation of the machine simulates a rolling of the dice. Each window is further capable of displaying a special symbol, preferably a star, the appearance of which may result in enhanced payout. For example, if one star appears on one line of play, the appearance of a second star for that line on a subsequent roll results in an additional payout. As another example, the appearance of a double star by itself results in an additional payout. Additional payouts may also be available through the subsequent appearance of the POINT, if achieved.

### FIELD OF THE INVENTION

This invention relates generally to gaming apparatus and, in particular, to a multi-line casino-type gaming machine

### BACKGROUND OF THE INVENTION

The slot machine or ‘one-armed bandit’ is over 100 years old. It is believed that the first machine was invented by Charles Fey in San Francisco in 1894. His “Liberty Bell” machine, invented in 1898, is considered to be the forerunner of the American slot machine in that it incorporated three mechanical reels, each with multiple symbols. Today's machines, in contrast, are microprocessor-controlled and feature up to five spinning reels holding hundreds of symbols.

Slot machines grew in popularity in the 30's and 40's due in part to the development of Las Vegas. In fact, revenues from slot machines have grown faster than table games, and it is believed that slot machine revenues now account for more than two-thirds of casino revenues in the United States.

The typical slot machine has three or more wheels with symbols that spin when a handle is pulled. The occurrence of certain symbol combinations on a pay line results in various winning combinations. A posted payoff table tells the player what they win based on the combinations and the number of coins put in for the spin.

There are two kinds of slot machines, called straight slots and progressives. The machines are essentially the same, except that the former pays out in accordance with a predetermined amount, whereas the latter may include a jackpot that grows in each coin played in accordance with each coin paid. Progressive machines are conspicuous because they typically feature a flashing payoff sign posted near the winning machine.

There are many different types of machines besides the straight slot and progressive varieties. Machines vary in terms of how much they cost to play, the number of wheels, and single versus multiple pay lines. Indeed, due to the increasing popularity of such machines, casinos are anxious for new games that are easier to play, attractive to look at, and give players the feeling that they will “be lucky.”

### SUMMARY OF THE INVENTION

This invention resides in a multi-line gaming machine and method of play, which combines enjoyable features from rolling dice and slot-type machines. The machine itself includes a player-facing front panel having a plurality of windows, each window being operative to display one of a plurality of changing symbols, and wherein pairs of windows represent lines of play. A player activates the machine, typically through the delivery of money or tokens sufficient to fund one or more lines of play, followed by the pull of a level or other type of control, to cause the window displays to change. When the displays come to rest, the apparatus alerts a player to various WIN/LOSS combinations, including a WIN if one or more predetermined winning combinations of numbers or symbols appear in the windows, a LOSS if one or more predetermined losing combinations of the numbers or symbols appear in the windows, and a POINT useful in future play of the machine in the absence of a WIN or LOSS.

In the preferred embodiment, there are three or more windows, and the pairs of windows representing different lines of play are overlapping such that each window comprises one half of a different line. Also, the numbers and symbols are preferably representative of faces on a specialized die, such that the activation of the machine simulates a rolling of the dice. Each window is further capable of displaying a special symbol, preferably a star, the appearance of which may result in enhanced payout. For example, if one star appears on one line of play, the appearance of a second star for that line on a subsequent roll results in an additional payout. As another example, the appearance of a double star by itself results in an additional payout.

Additional payouts may also be available through the subsequent appearance of the POINT, if declared. If a POINT is not achieved on the first roll, rules are also preferably available to set the POINT on a subsequent roll. In a comprehensive embodiment of the invention, the following rules would preferably apply on the first roll of the dice:

a WIN on 7, 11 or Double Star,

a LOSS on 3 (on two dice),

a POINT on 4, 5, 6, 8, 9 or 10 (on two dice), and

that a Single Star on either die becomes a Live Star, and on each subsequent roll of the dice:

a WIN on Double Star,

a WIN if there is a POINT and the POINT is hit,

a WIN if there is a Live Star and a Single Star shows on either die,

a LOSS if there is not a Live Star and a POINT, and the POINT or a Star is not rolled,

a LOSS if there is a POINT and a 7 is hit,

without a POINT, that a roll of 4, 5, 6, 8, 9 or 10 (on two dice) then becomes the POINT,

CONTINUE ROLLING if there is a LIVE STAR, and a STAR, POINT or 7 is not rolled, and

CONTINUE ROLLING if there is not a LIVE STAR, and a LIVE STAR is rolled.

In terms of apparatus, a preferred machine includes separate windows to indicate a player's POINT, the appearance of LIVE STARS, DOUBLE STARS, AND game status.

### BRIEF DESCRIPTION OF THE DRAWINGS

FIG. 1 shows the face of a machine according to the invention before play begins;

FIG. 2 is an illustration of the five lines used in accordance with the preferred embodiment;

FIG. 3 is an example of a play condition in the midst of a game following a hypothetical first roll; and

FIG. 4 illustrates the state of a game on a hypothetical second roll following the state of the machine depicted in FIG. 3.

### DETAILED DESCRIPTION OF THE INVENTION

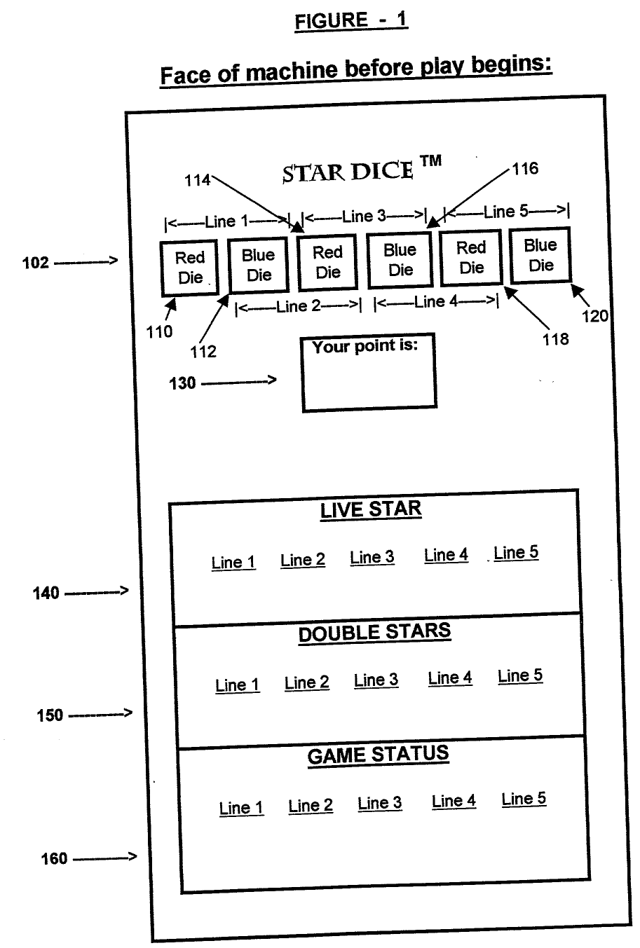

Reference will now be made to the figures, wherein like numerals refer to the same items throughout the various drawing sheets. FIG. 1 shows the face of a machine according to the invention before play begins. The user interface includes an upper line 102 of windows 110 through 120 having changeable numeric and/or symbolic displays. The windows are preferably arranged in pairs to form different lines of play. In the preferred embodiment, the windows are overlapping, such that most of the windows form half of the different lines, as shown by “line 1” through “line 5.”

In the preferred embodiment, the windows represent the faces of simulated dice of alternating colors, each die including one face with a special symbol in the form of a star. Each die preferably has six states (as with the faces of a real die), with each blue die containing a 1, 2, 3, 4, 5 and star, and with each red dice containing a star, 2, 3, 4, 5 and 6. However, although the preferred configuration utilizes six changeable die symbols in certain colors, it will be appreciated that more or fewer symbols may be used with different graphics and/or colors. In addition, although this description assumes that the symbols are presented on mechanically rotatable wheels, electronic displays may alternatively be used. Indeed, with the use of electronic display, a video of dice in a shaker being rolled onto a surface may be used in lieu of separate die windows. Also, although the dice feature a special symbol in the form of a star, the term STAR should be taken to mean any non-numerical symbol, regardless of the number present on each simulated die.

Below the line of windows 102, is a POINT window 130 which will be explained in more detail below. Below the point space 130, are three other areas called “LIVE STAR” 140; “DOUBLE STARS” 150, and “GAME STATUS” 160. The function of these other areas will also be better understood with reference to the description of the play sequence, as follows:

### RULES OF THE GAME

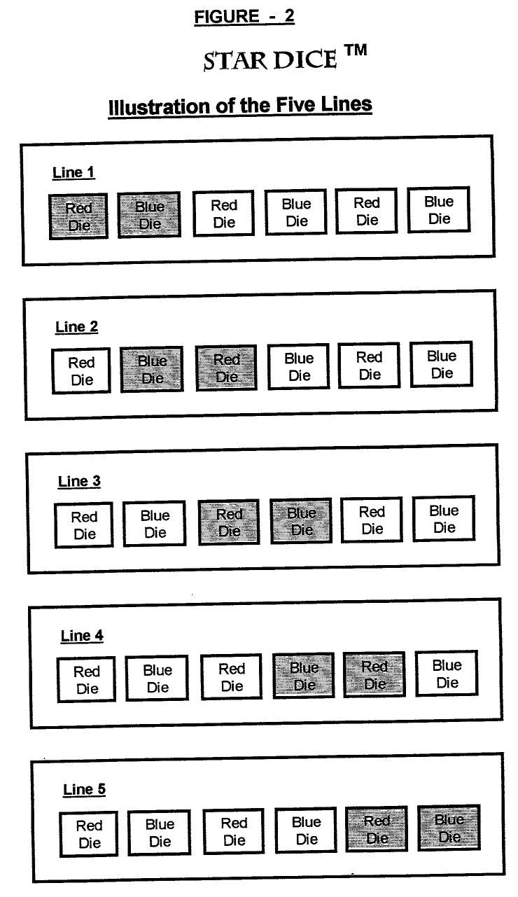

Each player may play up to 5 lines, as shown in FIG. 1 and perhaps better seen on FIG. 2. It is assumed that money or tokens are supplied to the game sufficient to fund one or more lines in increments. For example, each quarter, dollar, or casino token may increment the number of lines on a per-insertion basis. Although additional funding may be required for subsequent machine activations, in the preferred embodiment, the initial funding may be used for subsequent “rolls” until there in a final WIN/LOSS determination.

To activate the machine, the player pulls a lever (or pushes a button), and the wheels spin, as funded. When the wheels (or displays) come to rest, a set of WIN/LOSE rules are applied with respect to each line, as follows:

On the 1st “Roll”:

a WIN on 7, 11 or Double Star,

a LOSS on 3 (on two dice),

a POINT on 4, 5, 6, 8, 9 or 10 (on two dice), and

that a Single Star on either die becomes a Live Star. On each subsequent roll of the dice:

a WIN on Double Star,

a WIN if there is a POINT and the POINT is hit,

a WIN if there is a Live Star and a Single Star shows on either die,

a LOSS if there is not a Live Star and a POINT, and the POINT or a Star is not rolled,

a LOSS if there is a POINT and a 7 is hit,

without a POINT, that a roll of 4, 5, 6, 8, 9 or 10 (on two dice) then becomes the POINT,

CONTINUE ROLLING if there is a LIVE STAR, and a STAR, POINT or 7 is not rolled, and

CONTINUE ROLLING if there is not a LIVE STAR, and a LIVE STAR is rolled.

Determining a Player's Point in Multiple-line Games

For all lines which do not hit a 7, 11, Double STAR or 3 on the first “roll,” the POINT becomes the POINT “rolled” on line 1. If no POINT is rolled on line 1, then line 2 is used, and so on. In other words, all lines that were not won or lost on the first “roll” get the same POINT for the remainder of the game in progress.

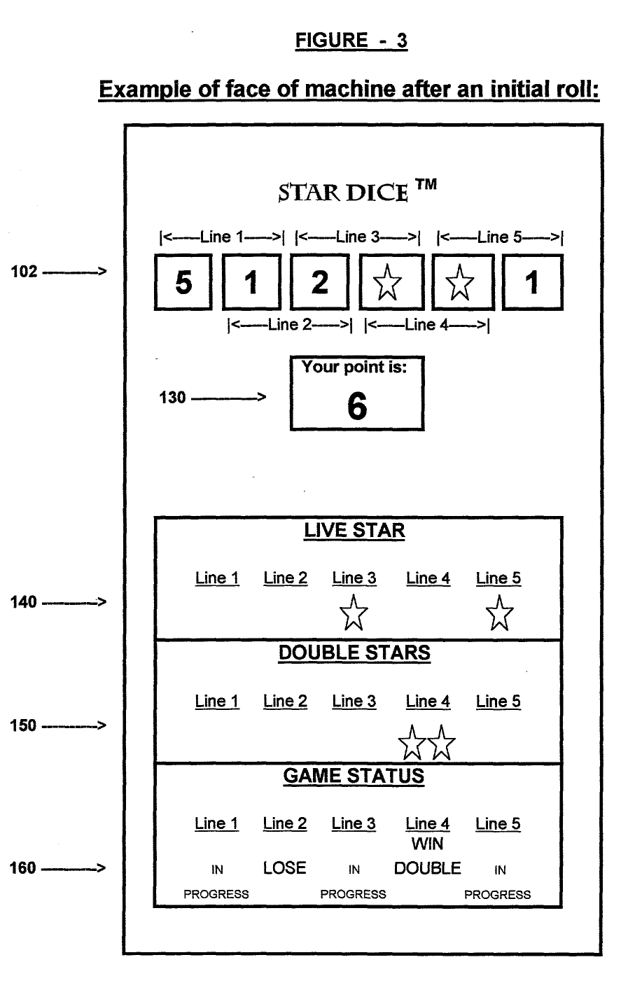

To help understand the sequence of play according to the preferred embodiment, reference is made to FIG. 3, which shows the face of a machine in the midst of a game. In this case, it is presumed that the player has provided sufficient funds or tokens to play all five lines, and the goal has resulted in the entry shown in the windows 102. Under the preferred rules, since a 5 and 1 have appeared on line 1, the POINT is a 6, as shown in the window 130. Referring to the GAME STATUS area, realization of a POINT is neither a WIN or a LOSS, and an “IN PROGRESS” condition is shown for line 1.

In line 2, the combination of a 1 and 2 is a 3 and, under the preferred rules, a LOSS is shown for line 2 in the GAME STATUS box. In line 3, a LIVE STAR is showing, which is recorded in the LIVE STAR box 140. Since this in and of itself, is not a WIN or LOSS, so “IN PROGRESS” is shown for line 3.

The single STAR of line 3 carries over to line 4, and the first STAR of line 5 results in a DOUBLE STAR for line 4 which shows in the DOUBLE STAR area 150 and in the game status area as winning double (or whatever condition the casino may impose). Line 5 is similar to line 3, in that a single star is showing, with the game status being “IN PROGRESS.”

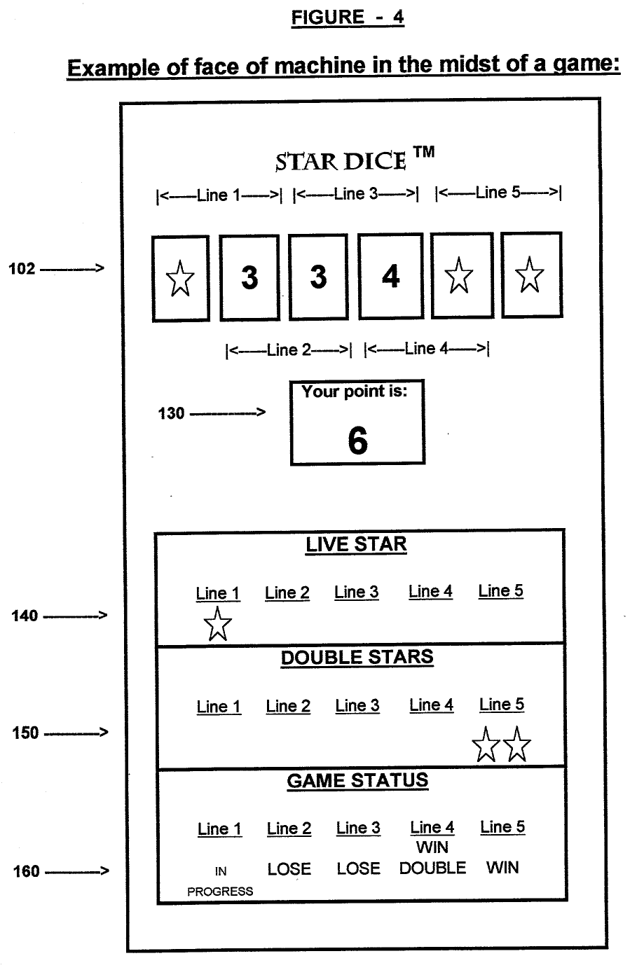

FIG. 4 illustrates the state of a game on the second roll following the condition shown in FIG. 3. Again, it is assumed that all six lines have been funded. In line 1, the combination of a 3 and STAR places a LIVE STAR in line 1 with the game for that line continuing to be IN PROGRESS. The line 2 outcome was determined on the first roll, so the game status continues to indicate “LOSE.” In line 3, there is a LOSS, since there was a POINT and a 7 was hit. The line 4 outcome was determined on the first roll, so the game status continues to indicate “WIN DOUBLE.” Finally, in line 5, there is now a DOUBLE STAR showing, resulting in a double WIN, as indicated in the game status area.

Payout

It is assumed that the level of payout for each WIN will be determined in accordance with house rules, the amount of machine funding, and perhaps other factors. In the preferred embodiment, however, the following enhanced payouts would be recommended:

Consecutive DOUBLE STARS pay off in increasing increments, preferably as follows:

2 consecutive DOUBLE STARS, same line: 25 to 1

3 consecutive DOUBLE STARS, same line: 500 to 1

4 consecutive DOUBLE STARS, same line: 10,000 to 1 (or, with 5 coins, 20,000 to 1)

The preferred embodiment also recommends ACROSS THE BOARD BONUS PAYOFFS, but only when all 5 lines are played. These payoffs are in addition to any single line payoffs, and all DOUBLE STARS and LIVE STARS continue under the normal rules without regard to this additional, special payoff. These are only paid on the first “roll” of each game. The payoff rates are the total payoff for the “roll,” not per line.

Additional payoffs for 4, 5 or 6 consecutive dice with the same number, as follows:

4 consecutive same numbers pays 5 to 1

5 consecutive same numbers pays 50 to 1

6 consecutive same numbers pays 500 to 1

Additional payoffs for 4, 5 or 6 consecutive STARS, as follows:

4 consecutive stars pays 15 to 1

5 consecutive stars pays 150 to 1

6 consecutive stars pays 1,500 to 1

I claim:

1. A method of playing a game, comprising the steps of:
providing a gaming machine having a front panel with at least a pair of windows representing a line of play, each window displaying a number or symbol;
activating the machine to cause the window displays to change; and declaring:
a WIN if one or more predetermined winning combinations of numbers or symbols appear in the windows,
a LOSS if one or more predetermined losing combinations of the numbers or symbols appear in the windows, or
a POINT useful in future play of the machine in the absence of a WIN or LOSS.

2. The method of claim 1, wherein:
the numbers and symbols are representative of faces on a standard or specialized die; and
the activation of the machine simulates a rolling of the dice.

3. The method of claim 1, wherein:
there are three or more windows; and
the pairs of windows representing different lines of play are overlapping such that each window comprises one half of a different line.

4. The method of claim 1, wherein each window is capable of displaying at least one non-numerical symbol.

5. The method of claim 4, wherein the non-numerical symbol is a star.

6. The method of claim 4, wherein the appearance of the non-numerical symbol is temporarily registered for use in future play of the machine.

7. The method of claim 4, wherein the appearance of a pair of the non-numerical symbols results in an additional payout.

8. The method of claim 1, wherein:
there are multiple lines of play; and
if no POINT arises on line 1, subsequent lines are used in succession until a POINT is achieved.

9. A method of playing a game, comprising the steps of:
providing a gaming machine having a front panel with a plurality of windows, each window displaying a number or symbol representing the face of a specialized die, and wherein pairs of the windows represent different lines of play;
activating the machine to simulate a rolling of the dice to cause the window displays to change; and declaring:
a WIN if one or more predetermined winning combinations of numbers or symbols representing the appear in a line of play,
a LOSS if one or more predetermined losing combinations of the numbers or symbols appear in a line of play, or
a POINT useful in future play of the machine in the absence of a WIN or LOSS.

10. The method of claim 9, wherein the pairs of windows representing different lines of play are overlapping such that each window comprises one half of a different line.

11. The method of claim 9, wherein the symbol is a star.

12. The method of claim 9, wherein the appearance of a symbol on any line is temporarily registered for use in subsequent rolls of the dice.

13. The method of claim 9, wherein the appearance of a pair of the symbols on any line of play results in an additional payout.

14. The method of claim 9, including the step of declaring the following on the first roll of the dice:
a WIN on 7, 11 or Double Symbol,
a LOSS on 3 (on two dice),
a POINT on 4, 5, 6, 8, 9 or 10 (on two dice), and
that a Single Symbol on either die becomes LIVE.

15. The method of claim 14, including the step of declaring the following on subsequent rolls of the dice:
a WIN on Double Symbol,
a WIN if there is a POINT and the POINT is hit,
a WIN if there is a Live Symbol and a single symbol shows on either die,
a LOSS if there is not a Live Symbol but there is a POINT, and the POINT or Symbol is not rolled,
a LOSS if there is a POINT and a 7 is hit,
CONTINUE ROLLING if there is a Live Symbol, and a STAR, POINT or 7 is not rolled,
CONTINUE ROLLING if there is not a Live Symbol, and a Live Symbol is rolled, and
without a POINT, a roll of 4, 5, 6, 8, 9 or 10 (on two dice) becomes the point.

16. A multi-line gaming machine, comprising:
a plurality of windows, each window being operative to display one of a plurality of changing symbols, and wherein pairs of windows represent lines of play;
a user control for activating the machine to cause the window displays to change; and apparatus for alerting a player as to:
a WIN if one or more predetermined winning combinations of numbers or symbols appear in the windows,
a LOSS if one or more predetermined losing combinations of the numbers or symbols appear in the windows, or
a POINT useful in future play of the machine in the absence of a WIN or LOSS.
